(19) United States
(12) Patent Application Publication
(10) Pub. No.: US 2024/0279059 A1
(43) Pub. Date: Aug. 22, 2024

(54) PROCESS FOR THE PREPARATION OF A SYNTHESIS GAS

(71) Applicant: BASF SE, Ludwigshafen am Rhein (DE)

(72) Inventors: Armin LANGE DE OLIVEIRA, Heidelberg (DE); Sandra MAGNUS, Ludwigshafen am Rhein (DE); Andreas KUSCHEL, Ludwigshafen am Rhein (DE); Christiane KURETSCHKA, Ludwigshafen am Rhein (DE); Marcelo Daniel KAUFMAN RECHULSKI, Antwerp (BE)

(21) Appl. No.: 18/569,631

(22) PCT Filed: Jun. 14, 2022
(86) PCT No.: PCT/EP2022/066145

§ 371 Date: Dec. 13, 2023

(30) Foreign Application Priority Data
Jun. 15, 2021 (EP) 21179506.7

(51) Int. Cl. C01B 3/40; B01J 23/83

(52) U.S. Cl. CPC C01B 3/40; B01J 23/83; C01B 2203/0233; C01B 2203/0238; C01B 2203/1052; C01B 2203/1241

(57) ABSTRACT

A continuous process for reforming one or more hydrocarbons to a synthesis gas comprising hydrogen and carbon monoxide, the start-up phase of said process comprising (i) providing a reactor comprising a reaction zone which comprises a catalyst comprising a mixed oxide comprising cobalt and oxygen; (ii) continuously passing an inert gas stream through the reaction zone according to (i), said inert gas stream comprising one or more inert gases; (iii) continuously passing a reactant gas stream into the reaction zone obtained from (ii), wherein from 95 to 100 volume-% of the reactant gas stream passed into the reaction zone consist of the one or more hydrocarbons, carbon dioxide, and water; subjecting said reactant gas stream to reforming conditions in said reaction zone; and removing a product stream from said reaction zone, said product stream comprising hydrogen and carbon monoxide.

The present invention relates to a process for the preparation of a synthesis gas. Synthesis gas or syngas, is a fuel gas mixture consisting primarily of hydrogen, carbon monoxide, and very often some carbon dioxide. Synthesis gas can be produced from many sources, including natural gas, coal, or biomass in particular by reaction with steam and carbon dioxide. Synthesis gas is an important resource for production of hydrogen, ammonia, methanol, and synthetic hydrocarbon fuels. Preparation methods include steam reforming of natural gas or hydrocarbons to produce hydrogen.

In particular, the present invention relates to a continuous process for reforming one or more hydrocarbons to a synthesis gas comprising hydrogen and carbon monoxide, wherein a specific start-up phase of said process is applied. The start-up phase of the process distinguishes especially from common start-up phases in that the latter comprises, after having passed an inert gas stream through the reaction zone, passing a reactant gas stream into the reaction zone, wherein said reaction stream does not comprise carbon dioxide. The carbon dioxide feed is added to the reactant gas stream at a later point in time. In contrast thereto, the process of the present invention avoids such a step and the reactant gas stream introduced into the reaction zone also comprises carbon dioxide.

With regard to common reforming catalysts, WO 2013/118078 A1 discloses a hexaaluminate-containing catalyst, which comprises a hexaaluminate-containing phase that includes cobalt and at least one additional element from the group La, Ba, Sr. In addition to the hexaaluminate-containing phase, the catalyst can include a 0 to 50 weight-% oxide secondary phase. Further, a reforming process for converting hydrocarbons is disclosed, the method is characterized in that the catalyst is used at a process temperature greater than 700° C., the process pressure being greater than 5 bar. According to the examples, the reforming process started with introducing a reactant gas stream comprising methane and steam into the reactor at 850° C.

Further, US 2003/176278 A1 relates to metal-exchanged hexaaluminate catalysts that exhibit good catalytic activity and/or stability at high temperatures for extended periods with retention of activity as combustion catalysts, and more generally as oxidation catalysts, that make them eminently suitable for use in methane combustion, particularly for use in natural gas fired gas tur-bines. According to the examples, the activity of the catalysts for methane combustion has been measured by flowing a mixture of 3% methane in air over the catalyst at a pressure of 517 kPa (75 psi) and a gas hourly space velocity of 17000/h.

The conversion to a synthesis gas can be influenced, for example, via the temperature of the reaction, i.e. via the temperature of the reactor, of the catalyst, and of any gas stream, via the gas hourly space velocity and via the composition of any gas stream introduced into a reactor. More specifically, the production costs for reforming of hydrocarbons to a synthesis gas can be further improved by using a more active and selective catalyst, but also by increasing the stability of the catalyst and by improving the cost of the catalyst production. The increase of the conversion of hydrocarbons is very beneficial since it allows to reduce the size of the reactor and, consequently, of the reforming plant, the amount of required catalyst, and the size of recycles.

Usually, the start-up procedure for the conversion to a synthesis gas, i.e. reforming, includes a steam reforming phase where no carbon dioxide is introduced into the reactor. However, it has surprisingly been found that a specific sequence of parameters used for the start-up procedure for reforming can impact the activity in particular of Co-based catalysts positively. It is beneficial for the activity to start-up Co-based dry reforming catalysts w/o a steam reforming phase.

Therefore, it was an object of the present invention to provide an improved process for the production of a synthesis gas comprising hydrogen, carbon monoxide and carbon dioxide in the presence of a catalyst comprising a mixed oxide which particularly comprises cobalt providing for a low selectivity with respect to by-products and side-products of the reaction while, at the same time, allowing for high conversion rates with respect to the starting materials, in particular a hydrocarbon, preferably methane, and/or carbon dioxide.

Surprisingly, it was found that this problem can be solved if in the process for producing synthesis gas, in the presence of a catalyst, preferably a catalyst comprising a mixed oxide which particularly comprises cobalt, a specific sequence of process steps is carried out resulting in an improved activity of the catalyst.

Therefore, the present invention relates to a continuous process for reforming one or more hydrocarbons to a synthesis gas comprising hydrogen and carbon monoxide, the start-up phase of said process comprising
(i) providing a reactor comprising a reaction zone which comprises a catalyst comprising a mixed oxide comprising cobalt and oxygen;
(ii) continuously passing an inert gas stream through the reaction zone according to (i), said inert gas stream comprising one or more inert gases;
(iii) continuously passing a reactant gas stream into the reaction zone obtained from (ii), wherein from 95 to 100 volume-% of the reactant gas stream passed into the reaction zone consist of the one or more hydrocarbons, carbon dioxide, and water;

subjecting said reactant gas stream to reforming conditions in said reaction zone; and removing a product stream from said reaction zone, said product stream comprising hydrogen and carbon monoxide.

Further, the present invention relates to a continuous process for reforming one or more hydrocarbons to a synthesis gas comprising hydrogen and carbon monoxide, the start-up phase of said process comprising
(i) providing a reactor comprising a reaction zone which comprises a catalyst comprising a mixed oxide comprising cobalt and oxygen;
(ii) continuously passing an inert gas stream through the reaction zone according to (i), said inert gas stream comprising one or more inert gases;
(iii) continuously passing a reactant gas stream into the reaction zone obtained from (ii), wherein from 95 to 100 volume-% of the reactant gas stream passed into the reaction zone consist of the one or more hydrocarbons, carbon dioxide, and water;
subjecting said reactant gas stream to reforming conditions in said reaction zone; and removing a product stream from said reaction zone, said product stream comprising hydrogen and carbon monoxide, wherein during (iii), the reforming conditions in the reaction zone comprise a setting (iii.1) and a setting (iii.2) realized directly after the setting (iii.1), wherein the setting (iii.1) differs from the setting (iii.2) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone.

Yet further, the present invention relates to a continuous process for reforming one or more hydrocarbons to a synthesis gas comprising hydrogen and carbon monoxide, the start-up phase of said process comprising
(i) providing a reactor comprising a reaction zone which comprises a catalyst comprising a mixed oxide comprising cobalt and oxygen;
(ii) continuously passing an inert gas stream through the reaction zone according to (i), said inert gas stream comprising one or more inert gases;
(iii) continuously passing a reactant gas stream into the reaction zone obtained from (ii), wherein from 95 to 100 volume-% of the reactant gas stream passed into the reaction zone consist of the one or more hydrocarbons, carbon dioxide, and water;
subjecting said reactant gas stream to reforming conditions in said reaction zone; and removing a product stream from said reaction zone, said product stream comprising hydrogen and carbon monoxide, wherein during (iii), the reforming conditions in the reaction zone comprise a setting (iii.1) and a setting (iii.2) realized directly after the setting (iii.1), wherein the setting (iii.1) differs from the setting (iii.2) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone, wherein during (iii), the reforming conditions in the reaction zone further comprise one or more settings (iii.x), wherein each of the settings (iii.x) differs from the setting (iii.x-1) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone;
wherein x is an integer andx>2.

As regards the reactor, it is preferred that the reactor provided according to (i) comprises two or more reaction zones. Further, it is preferred that the reactor provided according to (i) comprises two or more reactors arranged in parallel.

It is preferred that two or more reaction zones are arranged in parallel. Further, it is preferred that two or more reaction zones are serially arranged.

As regards the catalyst, it is preferred that the reaction zone according to (i) comprises the catalyst arranged as a fixed-bed catalyst.

It is preferred that from 99 to 100 weight-%, more preferably from 99.5 to 100 weight-%, more preferably from 99.9 to 100 weight-% of the catalyst consist of the mixed oxide.

The catalyst may be provided in the reaction zone in any suitable form. For instance, the catalyst may be a powder. It is preferred that the catalyst is a molding, more preferably a tablet.

It is preferred that the catalyst has a BET specific surface area in the range of from 7 to 13 m²/g, more preferably in the range of from 7.5 to 12 m²/g, more preferably in the range of from 8 to 12 m²/g, determined as described in Reference Example 1.

Further, it is preferred that the catalyst has a Langmuir specific surface area in the range of from 9 to 15 m²/g, determined as described in Reference Example 1.

As regards the mixed oxide comprised in the catalyst, it is preferred that from 5 to 10 weight-% of the mixed oxide consist of cobalt, calculated as element.

The cobalt comprised in the mixed oxide may be present in an amorphous phase and/or in a crystalline phase. It is preferred that the cobalt comprised in the mixed oxide is present in one or more crystalline phases, more preferably in at least two crystalline phases, more preferably in at least three crystalline phases, more preferably in three crystalline phases.

As regards the mixed oxide comprised in the catalyst, it is preferred that the mixed oxide further comprises one or more of lanthanum and aluminum, more preferably lanthanum and aluminum.

It is preferred that the mixed oxide further comprises aluminum. Further, in the case where the mixed oxide further comprises aluminum, it is preferred that in the mixed oxide the weight ratio of cobalt relative to aluminum, calculated as elements, is at least 0.1:1, more preferably in the range of from 0.13:1 to 0.3:1, more preferably in the range of from 0.15:1 to 0.25:1, more preferably in the range of from 0.17:1 to 0.22:1. Further, in the case where the mixed oxide further comprises aluminum, it is preferred that from 33 to 40 weight-%, more preferably from 34 to 38 weight-%, more preferably from 35 to 37 weight-%, more preferably from 35.5 to 36.5 weight-% of the mixed oxide consist of aluminum, calculated as element.

It is preferred that the mixed oxide further comprises lanthanum. Further, in the case where the mixed oxide further comprises lanthanum, it is preferred that in the mixed oxide, the weight ratio of cobalt relative to lanthanum, calculated as elements, is in the range of from 0.2:1 to 0.6:1, more preferably in the range of from 0.25:1 to 0.5:1. Further in the case where the mixed oxide further comprises lanthanum, it is preferred that from 15 to 25 weight-%, more preferably from 16 to 23 weight-%, of the mixed oxide consist of lanthanum, calculated as element.

As regards the mixed oxide, it is preferred that from 80 to 100 weight-% of the mixed oxide is in crystalline form, more preferably from 90 to 100 weight-%, more preferably from 92 to 100 weight-%.

It is particularly preferred that the mixed oxide further comprises lanthanum and aluminum. In the case where the mixed oxide further comprises lanthanum and aluminum, it is preferred that the mixed oxide comprises at least a crystalline phase of LaCoAl₁₁O₁₉ and a crystalline phase of LaAl(Co)O₃.

According to the present invention, the mixed oxide exhibits specific properties that can be determined via x-ray diffraction, in particular as described in Reference Example 2. Thus, further in the case where the mixed oxide further comprises lanthanum and aluminum, as well as at least a crystalline phase of LaCoAl₁₁O₁₉ and a crystalline phase of LaAl(Co)O₃, it is particularly preferred that in the mixed oxide, the weight ratio of LaCoAl₁₁O₁₉ relative to LaAl(Co)O₃ is at least 10:1, more preferably in the range of from 10:1 to 25:1, determined via XRD as described in Reference Example 2.

In the case where the mixed oxide further comprises lanthanum and aluminum, it is preferred that the mixed oxide comprises a crystalline phase LaAlO₃, more preferably a crystalline phase LaAlO₃ and a crystalline phase CoAl₂O₄, more preferably a crystalline phase LaAlO₃, a crystalline phase CoAl₂O₄, and a crystalline phase La(OH)₃.

Further, in the case where the mixed oxide further comprises lanthanum and aluminum, it is 35 preferred that the mixed oxide comprises a crystalline phase LaCoAl₁₁O₁₉ and a crystalline phase CoAl₂O₄. In the case where the mixed oxide comprises a crystalline phase LaCoAl₁₁O₁₉ and a crystalline phase CoAl₂O₄, it is preferred that the weight ratio of LaCoAl₁₁O₁₉ relative to CoAl₂O₄ is at least 10:1, more preferably in the range of from 12:1 to 30:1, determined via XRD as described in Reference Example 2.

The mixed oxide may further comprise other elements of the periodic table of elements. Thus, the mixed oxide may further comprise one or more of barium, strontium and a mixture thereof.

It is preferred that the catalyst is heated in one or more of (i), (ii) and (iii), more preferably in one or more of (ii) and (iii), more preferably in (ii) and (iii).

As regards the conditions for continuously passing an inert gas stream according to (ii) through the reaction zone according to (i), no particular restriction applies. It is preferred the catalyst is heated during (ii) to a temperature in the range of from 350 to 450° C., more preferably in the range of from 375 to 425° C.

As regards the conditions for continuously passing a reactant gas stream according to (iii) into the reaction zone obtained from (ii), again no particular restriction applies. It is preferred that the catalyst is heated during (iii) to a temperature in the range of from 550 to 980° C., more preferably in the range of from 575 to 975° C., more preferably in the range of from 600 to 950° C.

In general, it is preferred that the process is carried out by excluding oxygen (O₂). In particular, it is preferred that the reaction zone obtained from (ii) is essentially free of oxygen (O₂) prior to passing the reactant gas stream into the reactor according to (iii). It is particularly preferred that the reaction zone obtained from (ii) comprises from 0 to 0.1 volume-%, more preferably from 0 to 0.01 volume-%, more preferably from 0 to 0.001 volume-% of oxygen (O₂), prior to passing the reactant gas stream into the reactor according to (iii).

It is preferred that prior to (iii), no reactant stream is passed into the reaction zone according to (i), wherein the reactant stream comprises one or more of a hydrocarbon and water, more preferably comprising a hydrocarbon and water, said stream comprising from 0 to 0.1 volume-%, more preferably from 0 to 0.01 volume-%, more preferably from 0 to 0.001 volume-% carbon dioxide.

Further, it is preferred that prior to (iii), no stream consisting of from 95 to 100 volume-%, preferably of from 98 to 100 volume-%, more preferably of from 99 to 100 volume-%, of one or more of a hydrocarbon and water, preferably of a hydrocarbon and water, is passed into the reaction zone according to (i).

Further, as regards the reaction zone, it is preferred that the reaction zone obtained from (ii) and prior to (iii) is essentially free of one or more of carbon dioxide and oxygen (O₂), preferably free of carbon dioxide and oxygen (O₂). It is particularly preferred that the reaction zone obtained from (ii) and prior to (iii) comprises from 0 to 0.1 volume-%, more preferably from 0 to 0.01 volume-%, more preferably from 0 to 0.001 volume-% of one or more of carbon dioxide and oxygen (O₂), preferably of carbon dioxide and oxygen (O₂).

As regards the inert gas stream, it is preferred that from 95 to 100 volume-%, more preferably from 98 to 100 volume-%, more preferably from 99 to 100 volume-%, of the inert gas stream according to (ii) consist of one or more inert gases.

As regards the inert gases, no particular restriction applies such that any suitable inert gases may be used. It is preferred that the one or more inert gases according to (ii) comprise one or more of nitrogen and argon. Further, it is particularly preferred that the one or more inert gases are nitrogen and argon. Alternatively, it is particularly preferred that the one or more inert gases is nitrogen, preferably technical nitrogen.

As regards the conditions under which the inert gas stream is passed according to (ii) through the reaction zone according to (i), no particular restriction applies. It is preferred that according to (ii), the inert gas stream is passed through the reaction zone according to (i) at a gas hourly space velocity (GHSV) of the inert gas stream in the range of from 1000 to 10000 per hour, more preferably in the range of from 2000 to 6000 per hour, more preferably in the range of from 3000 to 4000 per hour.

As regards the reactant gas stream, no particular restriction applies as concerns the physical or chemical nature of the hydrocarbon. It is preferred that the hydrocarbon is one or more of methane, ethane, propane and butane, preferably methane.

It is preferred that in the reactant gas stream passed into the reaction zone obtained from (ii), the volume ratio of the hydrocarbon to the carbon dioxide is in the range of from 0.75:1 to 1.25:1, more preferably in the range of from 0.8:1 to 1.2:1, more preferably in the range of from 0.9:1 to 1.1:1, more preferably in the range of from 0.95:1 to 1.05:1.

Further, it is preferred that in the reactant gas stream passed into the reaction zone obtained from (ii), the volume ratio of the hydrocarbon to the water is in the range of from 1.7:1 to 2.9:1, more preferably in the range of from 1.8:1 to 2.8:1, more preferably in the range of from 1.85:1 to 2.75:1.

It is preferred that from 96 to 100 volume-%, more preferably from 98 to 100 volume-%, more preferably from 99 to 100 volume-%, more preferably from 99.5 to 100 volume-% of the reactant gas stream passed into the reaction zone obtained from (ii) consist of the hydrocarbon, the carbon dioxide, and the water.

No particular restriction applies as regards further components comprised in the reactant gas stream. For instance, the reactant gas stream passed into the reaction zone obtained from (ii) may further comprise one or more inert gases, more preferably one or more of nitrogen and argon, as an internal standard for testing purposes. In this regard, it is preferred that from 1 to 5 volume-%, more preferably from 2 to 5 volume-%, more preferably from 4.5 to 5 volume-% of the reactant gas stream passed into the reaction zone obtained from (ii) consist of the one or more inert gases. Therefore, it is particularly preferred that from 95 to 100 volume-%, more preferably from 96 to 100 volume-%, more preferably from 97 to 100 volume-%, more preferably from 99 to 100 volume-%, more preferably from 99.5 to 100 volume-% of the reactant gas stream consist of the hydrocarbon, the carbon dioxide, the water, and the one or more inert gases.

As regards the specific composition of the reactant gas stream prior to passing through the reaction zone obtained from (ii), no particular restriction applies. It is preferred that from 1 to 50 volume-%, preferably from 10 to 50 volume-%, more preferably from 30 to 50 volume-%, more preferably from 35 to 45 volume-%, more preferably from 37 to 40.5 volume-% of the reactant gas stream consist of the hydrocarbon prior to passing through the reaction zone obtained from (ii). Further, it is preferred that from 1 to 50 volume-%, preferably from 10 to 50 volume-%, more preferably from 30 to 50 volume-%, more preferably from 35 to 45 volume-%, more preferably from 37 to 40.5 volume-% of the reactant gas stream consist of carbon dioxide (CO₂) prior to passing through the reaction zone obtained from (ii). Further, it is preferred that from 1 to 50 volume-%, preferably from 5 to 35 volume-%, more preferably from 10 to 25 volume-%, preferably from 12 to 23 volume-%, more preferably from 14 to 21 volume-% of the reactant gas stream consist of water (H₂O) prior to passing through the reaction zone obtained from (ii).

As regards the reforming conditions in the reaction zone according to (ii), no particular restriction applies. It is preferred that the reforming conditions in the reaction zone according to (iii) comprise a pressure of the gas phase in the range of from 1 to 50 bar(abs), preferably in the range of from 10 to 40 bar(abs), more preferably in the range of from 15 to 30 bar(abs), more preferably in the range of from 17 to 23 bar(abs), more preferably in the range of from 19 to 21 bar(abs), more preferably in the range of from 19.5 to 20.5 bar(abs). Further, it is preferred that the reforming conditions in the reaction zone according to (iii) comprise a gas hourly space velocity (GHSV) of the reactant gas stream in the range of from 1000 to 7500 per hour, more preferably in the range of from 1250 to 7300 per hour, more preferably in the range of from 1500 to 7100 per hour, more preferably of from 3500 to 7500 per hour, more preferably of from 3700 to 7300 per hour, more preferably of from 3900 to 7100 per hour. Further, it is preferred that the reforming conditions in the reaction zone according to (iii) comprise a temperature of the gas phase in the reaction zone in the range of from 550 to 980° C., preferably in the range of from 575 to 975° C., more preferably in the range of from 600 to 950° C. Therefore, it is particularly preferred that the reforming conditions in the reaction zone according to (iii) comprise a pressure of the gas phase in the range of from 19.5 to 20.5 bar(abs), a gas hourly space velocity (GHSV) of the reactant gas stream in the range of from 3900 to 7100 per hour, and a temperature of the gas phase in the reaction zone in the range of from 600 to 950° C.

According to the present invention, it is conceivable that the reforming conditions in the reaction zone, in particular the volume ratios of hydrocarbon:carbon dioxide:water in the reactant gas stream passed into the reaction zone, the temperature in the reaction zone, and the gas hourly space velocity of the reactant gas stream passed into the reaction zone, is changed during (iii) to have different settings.

Therefore, it is particularly preferred that the continuous process for reforming one or more hydrocarbons to a synthesis gas comprising hydrogen and carbon monoxide, the start-up phase of said process comprises
(i) providing a reactor comprising a reaction zone which comprises a catalyst comprising a mixed oxide comprising cobalt and oxygen;
(ii) continuously passing an inert gas stream through the reaction zone according to (i), said inert gas stream comprising one or more inert gases;
(iii) continuously passing a reactant gas stream into the reaction zone obtained from (ii), wherein from 95 to 100 volume-% of the reactant gas stream passed into the reaction zone consist of the one or more hydrocarbons, carbon dioxide, and water;
subjecting said reactant gas stream to reforming conditions in said reaction zone; and removing a product stream from said reaction zone, said product stream comprising hydrogen and carbon monoxide, wherein during (iii), the reforming conditions in the reaction zone comprise a setting (iii.1) and a setting (iii.2) realized directly after the setting (iii.1), wherein the setting (iii.1) differs from the setting (iii.2) in at least one of
(a) the volume ratios of hydrocarbon:carbon dioxide:water in the reactant gas stream passed into the reaction zone;
(b) the temperature in the reaction zone;
(c) the gas hourly space velocity of the reactant gas stream passed into the reaction zone.

As regards the volume ratios of hydrocarbon:carbon dioxide:water in the reactant gas stream passed into the reaction zone, the temperature in the reaction zone, and the gas hourly space velocity of the reactant gas stream passed into the reaction zone according to the setting (iii.1), no particular restriction applies. It is preferred that the volume ratios hydrocarbon:carbon diox-ide:water in the reactant gas stream according to the setting (iii.1) are (2.5 to 2.9):(2.5 to 2.9):(0.8 to 1.2), more preferably (2.55 to 2.8):(2.55 to 2.8):(0.9 to 1.1), more preferably (2.6 to 2.75):(2.6 to 2.75):(0.95 to 1.05). Further, it is preferred that the temperature in the reaction zone according to the setting (iii.1) is in the range of from 550 to 980° C., more preferably in the range of from 575 to 975° C., more preferably in the range of from 600 to 950° C., more preferably in the range of from 880 to 920° C., more preferably in the range of from 890 to 910° C., more preferably of from 895 to 905° C. Further, it is preferred that the gas hourly space velocity of the reactant gas stream according to the setting (iii.1) is in the range of from 1000 to 7500 per hour, preferably in the range of from 1250 to 7300 per hour, more preferably in the range of from 1500 to 7100 per hour, more preferably in the range of from 3700 to 4300 per hour, more preferably in the range of from 3800 to 4200 per hour, more preferably in the range of from 3900 to 4100 per hour.

It is preferred that the setting (iii.1) is maintained for a period of time in the range of from 1 to 10 h, more preferably in the range of from 3 to 8 h, more preferably in the range of from 4 to 6 h.

As regards the volume ratios of hydrocarbon:carbon dioxide:water in the reactant gas stream passed into the reaction zone, the temperature in the reaction zone, and the gas hourly space velocity of the reactant gas stream passed into the reaction zone according to the setting (iii.2), again no particular restriction applies. It is preferred that the volume ratios hydrocarbon:carbon dioxide:water in the reactant gas stream according to the setting (iii.2) are (2.5 to 2.9):(2.5 to 2.9):(0.8 to 1.2), more preferably (2.55 to 2.8):(2.55 to 2.8):(0.9 to 1.1), more preferably (2.6 to 2.75):(2.6 to 2.75):(0.95 to 1.05). Further, it is preferred that the temperature in the reaction zone according to the setting (iii.2) is in the range of from 550 to 980° C., more preferably in the range of from 575 to 975° C., more preferably in the range of from 600 to 970° C., more preferably in the range of from 930 to 970° C., more preferably in the range of from 940 to 960° C., more preferably in the range of from 945 to 955° C. Further, it is preferred that the gas hourly space velocity according to the setting (iii.2) is in the range of from 1000 to 7500 per hour, more preferably in the range of from 1250 to 7300 per hour, more preferably in the range of from 1500 to 7100 per hour, more preferably in the range of from 3700 to 4300 per hour, more preferably in the range of from 3800 to 4200 per hour, more preferably in the range of from 3900 to 4100 per hour.

It is preferred that the setting (iii.2) is maintained for a period of time in the range of from 10 to 50 h, preferably in the range of from 20 to 40 h, more preferably in the range of from 30 to 35 h.

In the case where the reforming conditions in the reaction zone during (iii) comprise a setting (iii.1) and a setting (iii.2) realized directly after the setting (iii.1), it is preferred that the reforming conditions in the reaction zone further comprise a setting (iii.3) realized directly after the setting (iii.2), wherein the setting (iii.3) differs from setting (iii.2) in at least one of
(a) the volume ratios of hydrocarbon:carbon dioxide:water in the reactant gas stream passed into the reaction zone;
(b) the temperature in the reaction zone;
(c) the gas hourly space velocity of the reactant gas stream passed into the reaction zone.

As regards the volume ratios of hydrocarbon:carbon dioxide:water in the reactant gas stream passed into the reaction zone, the temperature in the reaction zone, and the gas hourly space velocity of the reactant gas stream passed into the reaction zone according to the setting (iii.3), again no particular restriction applies. It is preferred that the volume ratios hydrocarbon:carbon dioxide:water in the reactant gas stream according to the setting (iii.3) are (1.7 to 2.1):(1.7 to 2.1):(0.8 to 1.2), more preferably (1.8 to 1.95):(1.8 to 1.95):(0.9 to 1.1), more preferably (1.85 to 1.9):(1.85 to 1.9):(0.95 to 1.05). Further, it is preferred that the temperature in the reaction zone according to the setting (iii.3) is in the range of from 550 to 980° C., more preferably in the range of from 575 to 975° C., preferably in the range of from 600 to 970° C., more preferably in the range of from 930 to 970° C., more preferably in the range of from 940 to 960° C., more preferably in the range of from 945 to 955° C. Further, it is preferred that the gas hourly space velocity according to the setting (iii.3) is in the range of from 1000 to 7500 per hour, more preferably in the range of from 1250 to 7300 per hour, more preferably in the range of from 1500 to 7100 per hour, more preferably of from 3700 to 4300 per hour, more preferably in the range of from 3800 to 4200 per hour, more preferably in the range of from 3900 to 4100 per hour.

It is preferred that the setting (iii.3) is maintained for a period of time in the range of from 5 to 50 h, preferably in the range of from 10 to 40 h, more preferably in the range of from 20 to 30 h.

In the case where the reforming conditions in the reaction zone during (iii) comprise a setting (iii.3) realized directly after the setting (iii.2), it is preferred that the reforming conditions in the reaction zone further comprise a setting (iii.4) realized directly after the setting (iii.3), wherein the setting (iii.4) differs from setting (iii.3) in at least one of
(a) the volume ratios of hydrocarbon:carbon dioxide:water in the reactant gas stream passed into the reaction zone;
(b) the temperature in the reaction zone;
(c) the gas hourly space velocity of the reactant gas stream passed into the reaction zone.

As regards the volume ratios of hydrocarbon:carbon dioxide:water in the reactant gas stream passed into the reaction zone, the temperature in the reaction zone, and the gas hourly space velocity of the reactant gas stream passed into the reaction zone according to the setting (iii.4), again no particular restriction applies. It is preferred that the volume ratios hydrocarbon:carbon dioxide:water in the reactant gas stream according to the setting (iii.4) are (1.7 to 2.1):(1.7 to 2.1):(0.8 to 1.2), more preferably (1.8 to 1.95):(1.8 to 1.95):(0.9 to 1.1), more preferably (1.85 to 1.9):(1.85 to 1.9):(0.95 to 1.05). Further, it is preferred the temperature in the reaction zone according to the setting (iii.4) is in the range of from 550 to 980° C., more preferably in the range of from 575 to 975° C., more preferably in the range of from 600 to 970° C., more preferably of from 930 to 970° C., more preferably in the range of from 940 to 960° C., more preferably in the range of from 945 to 955° C. Further, it is preferred that the gas hourly space velocity according to the setting (iii.4) is in the range of from 1000 to 7500 per hour, more preferably in the range of from 1250 to 7300 per hour, more preferably in the range of from 1500 to 7100 per hour, more preferably of from 6700 to 7100 per hour, more preferably in the range of from 6800 to 7100 per hour, more preferably in the range of from 6900 to 7100 per hour.

It is preferred that the setting (iii.4) is maintained for a period of time in the range of from 2 to 30 hours, preferably in the range of from 5 to 20 h, more preferably in the range of from 10 to 15 h.

In the case where the reforming conditions in the reaction zone during (iii) comprise a setting (iii.4) realized directly after the setting (iii.3), it is preferred that the reforming conditions in the reaction zone further comprise a setting (iii.5) realized directly after the setting (iii.4), wherein the setting (iii.5) differs from setting (iii.4) in at least one of
(a) the volume ratios of hydrocarbon:carbon dioxide:water in the reactant gas stream passed into the reaction zone;
(b) the temperature in the reaction zone;
(c) the gas hourly space velocity of the reactant gas stream passed into the reaction zone.

As regards the volume ratios of hydrocarbon:carbon dioxide:water in the reactant gas stream passed into the reaction zone, the temperature in the reaction zone, and the gas hourly space velocity of the reactant gas stream passed into the reaction zone according to the setting (iii.5), again no particular restriction applies. It is preferred that the volume ratios hydrocarbon:carbon dioxide:water in the reactant gas stream according to the setting (iii.5) are (2.5 to 2.9):(2.5 to 2.9):(0.8 to 1.2), more preferably (2.55 to 2.8):(2.55 to 2.8):(0.9 to 1.1), more preferably (2.6 to 2.75):(2.6 to 2.75):(0.95 to 1.05). Further, it is preferred that the temperature in the reaction zone according to the setting (iii.5) is in the range of from 550 to 980° C., more preferably in the range of from 575 to 975° C., more preferably in the range of from 600 to 970° C., more preferably of from 930 to 970° C., more preferably in the range of from 940 to 960° C., more preferably in the range of from 945 to 955° C. Further, it is preferred that the gas hourly space velocity according to the setting (iii.5) is in the range of from 1000 to 7500 per hour, more preferably in the range of from 1250 to 7300 per hour, more preferably in the range of from 1500 to 7100 per hour, more preferably of from 6700 to 7100 per hour, more preferably in the range of from 6800 to 7100 per hour, more preferably in the range of from 6900 to 7100 per hour.

It is preferred that the setting (iii.5) is maintained for a period of time in the range of from 2 to 30 h, more preferably in the range of from 5 to 20 h, more preferably in the range of from 10 to 15 h.

In the case where the reforming conditions in the reaction zone during (iii) comprise a setting (iii.5) realized directly after the setting (iii.4), it is preferred that the reforming conditions in the reaction zone further comprise a setting (iii.6) realized directly after the setting (iii.5), wherein the setting (iii.6) differs from setting (iii.5) in at least one of
(a) the volume ratios of hydrocarbon:carbon dioxide:water in the reactant gas stream passed into the reaction zone;
(b) the temperature in the reaction zone;
(c) the gas hourly space velocity of the reactant gas stream passed into the reaction zone.

As regards the volume ratios of hydrocarbon:carbon dioxide:water in the reactant gas stream passed into the reaction zone, the temperature in the reaction zone, and the gas hourly space velocity of the reactant gas stream passed into the reaction zone according to the setting (iii.6), again no particular restriction applies. It is preferred that the volume ratios hydrocarbon:carbon dioxide:water in the reactant gas stream according to the setting (iii.6) are (1.7 to 2.1):(1.7 to 2.1):(0.8 to 1.2), more preferably (1.8 to 1.95):(1.8 to 1.95):(0.9 to 1.1), more preferably (1.85 to 1.9):(1.85 to 1.9):(0.95 to 1.05). Further, it is preferred that the temperature in the reaction zone according to the setting (iii.6) is in the range of from 550 to 980° C., more preferably in the range of from 575 to 975° C., more preferably in the range of from 600 to 970° C., more preferably of from 930 to 970° C., more preferably in the range of from 940 to 960° C., more preferably in the range of from 945 to 955° C. Further, it is preferred that the gas hourly space velocity according to the setting (iii.6) is in the range of from 1000 to 7500 per hour, preferably in the range of from 1250 to 7300 per hour, more preferably in the range of from 1500 to 7100 per hour, more preferably of from 3700 to 4300 per hour, more preferably in the range of from 3800 to 4200 per hour, more preferably in the range of from 3900 to 4100 per hour. It is preferred that the setting (iii.6) is maintained for a period of time in the range of from 2 to 30 h, preferably in the range of from 5 to 20 h, more preferably in the range of from 10 to 15 h.

In the case where the reforming conditions in the reaction zone during (iii) comprise a setting (iii.6) realized directly after the setting (iii.5), the reforming conditions in the reaction zone may further comprise one or more settings (iii.x) realized directly after the setting (iii.6), wherein each of the settings (iii.x) differs from the setting (iii.x-1) in at least one of
(a) the volume ratios of hydrocarbon:carbon dioxide:water in the reactant gas stream passed into the reaction zone;
(b) the temperature in the reaction zone;
(c) the gas hourly space velocity of the reactant gas stream passed into the reaction zone; wherein x is an integer andx>6.

All cited documents are incorporated herein by reference.

The unit bar(abs) refers to an absolute pressure wherein 1 bar equals 105 Pa.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.
1. A continuous process for reforming one or more hydrocarbons to a synthesis gas comprising hydrogen and carbon monoxide, the start-up phase of said process comprising
   (i) providing a reactor comprising a reaction zone which comprises a catalyst comprising a mixed oxide comprising cobalt and oxygen;
   (ii) continuously passing an inert gas stream through the reaction zone according to (i), said inert gas stream comprising one or more inert gases;
   (iii) continuously passing a reactant gas stream into the reaction zone obtained from (ii), wherein from 95 to 100 volume-% of the reactant gas stream passed into the reaction zone consist of the one or more hydrocarbons, carbon dioxide, and water;
   subjecting said reactant gas stream to reforming conditions in said reaction zone; and
   removing a product stream from said reaction zone, said product stream comprising hydrogen and carbon monoxide.
2. The process of embodiment 1, wherein the reaction zone according to (i) comprises the catalyst arranged as a fixed-bed catalyst.
3. The process of embodiment 1 or 2, wherein the reactor provided according to (i) comprises two or more reaction zones.
4. The process of embodiment 3, wherein two or more reaction zones are arranged in parallel.
5. The process of embodiment 3 or 4, wherein two or more reaction zones are serially arranged.
6. The process of any one of embodiment 1 to 5, wherein the reactor provided according to (i) comprises two or more reactors arranged in parallel.
7. The process of any one of embodiments 1 to 6, wherein from 99 to 100 weight-%, preferably from 99.5 to 100 weight-%, more preferably from 99.9 to 100 weight-% of the catalyst consist of the mixed oxide.
8. The process of any one of embodiments 1 to 7, wherein the catalyst is a molding, preferably a tablet.
9. The process of any one of embodiments 1 to 8, wherein the catalyst has a BET specific surface area in the range of from 7 to 13 m²/g, preferably in the range of from 7.5 to 12 m²/g, more preferably in the range of from 8 to 12 m²/g, determined as described in Reference Example 1.
10. The process of any one of embodiments 1 to 9, wherein the catalyst has a Langmuir specific surface area in the range of from 9 to 15 m²/g, determined as described in Reference Example 1.
11. The process of any one of embodiments 1 to 10, wherein from 5 to 10 weight-% of the mixed oxide consist of cobalt, calculated as element.
12. The process of any one of embodiments 1 to 11, wherein the cobalt is present in one or more crystalline phases, preferably in at least two crystalline phases, more preferably in at least three crystalline phases, more preferably in three crystalline phases.
13. The process of any one of embodiments 1 to 12, wherein the mixed oxide further comprises one or more of lanthanum and aluminum, preferably lanthanum and aluminum.
14. The process of any one of embodiments 1 to 13, wherein the mixed oxide further comprises aluminum, and wherein in the mixed oxide, the weight ratio of cobalt relative to aluminum, calculated as elements, is preferably at least 0.1:1, more preferably in the range of from 0.13:1 to 0.3:1, more preferably in the range of from 0.15:1 to 0.25:1, more preferably in the range of from 0.17:1 to 0.22:1.
15. The process of any one of embodiments 1 to 14, wherein the mixed oxide further comprises lanthanum, and wherein in the mixed oxide, the weight ratio of cobalt relative to lanthanum, calculated as elements, is preferably in the range of from 0.2:1 to 0.6:1, preferably in the range of from 0.25:1 to 0.5:1.
16. The process of any one of embodiments 1 to 15, wherein the mixed oxide further comprises lanthanum, wherein from 15 to 25 weight-%, preferably from 16 to 23 weight-%, of the mixed oxide consist of lanthanum, calculated as element.
17. The process of any one of embodiments 1 to 16, wherein the mixed oxide further comprises aluminum, wherein from 33 to 40 weight-%, preferably from 34 to 38 weight-%, more preferably from 35 to 37 weight-%, more preferably from 35.5 to 36.5 weight-% of the mixed oxide consist of aluminum, calculated as element.
18. The process of any one of embodiments 1 to 17, wherein from 80 to 100 weight-% of the mixed oxide is in crystalline form, preferably from 90 to 100 weight-%, more preferably from 92 to 100 weight-%.
19. The process of any one of embodiments 1 to 18, wherein the mixed oxide further comprises lanthanum and aluminum, wherein the mixed oxide comprises at least a crystalline phase of LaCoAl₁₁O₁₉ and a crystalline phase of LaAl(Co)O₃.
20. The process of embodiment 19, wherein in the mixed oxide, the weight ratio of LaCoAl₁₁O₁₉ relative to LaAl(Co)O₃ is at least 10:1, preferably in the range of from 10:1 to 25:1, determined via XRD as described in Reference Example 2.
21. The process of any one of embodiments 1 to 20, wherein the mixed oxide further comprises lanthanum and aluminum, and wherein the mixed oxide comprises a crystalline phase LaAlO₃, preferably a crystalline phase LaAlO₃ and a crystalline phase CoAl₂O₄, more preferably a crystalline phase LaAlO₃, a crystalline phase CoAl₂O₄, and a crystalline phase La(OH)₃.
22. The process of any one of embodiments 1 to 21, wherein the mixed oxide further comprises lanthanum and aluminum, and wherein the mixed oxide comprises a crystalline phase LaCoAl₁₁O₁₉ and a crystalline phase CoAl₂O₄.
23. The process of any one of embodiments 1 to 22, wherein the mixed oxide further comprises lanthanum and aluminum, and wherein the mixed oxide comprises a crystalline phase LaCoAl₁₁O₁₉ and a crystalline phase CoAl₂O₄, wherein the weight ratio of LaCoAl₁₁O₁₉ relative to CoAl₂O₄ is preferably at least 10:1, more preferably in the range of from 12:1 to 30:1, determined via XRD as described in Reference Example 2.
24. The process of any one of embodiments 1 to 23, wherein the mixed oxide further comprises one or more of barium, strontium and a mixture thereof.
25. The process of any one of embodiments 1 to 24, wherein the catalyst is heated in one or more of (i), (ii) and (iii), preferably in one or more of (ii) and (iii), more preferably in (ii) and (iii).
26. The process of any one of embodiments 1 to 25, wherein during (ii), the catalyst is heated to a temperature in the range of from 350 to 450° C., preferably in the range of from 375 to 425° C.
27. The process of any one of embodiments 1 to 26, wherein during (iii), the catalyst is heated to a temperature in the range of from 550 to 980° C., preferably in the range of from 575 to 975° C., more preferably in the range of from 600 to 950° C.
28. The process of any one of embodiments 1 to 27, wherein prior to passing the reactant gas stream into the reactor according to (iii), the reaction zone obtained from (ii) comprises from 0 to 0.1 volume-%, preferably from 0 to 0.01 volume-%, more preferably from 0 to 0.001 volume-% of oxygen (O₂).
29. The process of any one of embodiments 1 to 28, wherein prior to (iii), no reactant stream comprising one or more of a hydrocarbon and water, preferably comprising a hydrocarbon and water, said stream comprising from 0 to 0.1 volume-%, more preferably from 0 to 0.01 volume-%, more preferably from 0 to 0.001 volume-% carbon dioxide, is passed into the reaction zone according to (i).
30. The process of any one of embodiments 1 to 29, wherein prior to (iii), no stream consisting of from 95 to 100 volume-%, preferably of from 98 to 100 volume-%, more preferably of from 99 to 100 volume-%, of one or more of a hydrocarbon and water, preferably of a hydrocarbon and water, is passed into the reaction zone according to (i).
31. The process of any one of embodiments 1 to 30, wherein the reaction zone obtained from (ii) and prior to (iii) comprises from 0 to 0.1 volume-%, preferably from 0 to 0.01 volume-%, more preferably from 0 to 0.001 volume-% of one or more of carbon dioxide and oxygen (O₂), preferably of carbon dioxide and oxygen (O₂).
32. The process of any one of embodiments 1 to 31, wherein from 95 to 100 volume-%, preferably from 98 to 100 volume-%, more preferably from 99 to 100 volume-%, of the inert gas stream according to (ii) consist of one or more inert gases.
33. The process of any one of embodiments 1 to 32, wherein the one or more inert gases according to (ii) comprise one or more of nitrogen and argon.
34. The process of any one of embodiments 1 to 33, wherein the one or more inert gases are nitrogen and argon.
35. The process of any one of embodiments 1 to 33, wherein the one or more inert gases is nitrogen, preferably technical nitrogen.
36. The process of any one of embodiments 1 to 35, wherein according to (ii), the inert gas stream is passed through the reaction zone according to (i) at a gas hourly space velocity (GHSV) of the inert gas stream in the range of from 1000 to 10000 per hour, preferably in the range of from 2000 to 6000 per hour, more preferably in the range of from 3000 to 4000 per hour.
37. The process of any one of embodiments 1 to 36, wherein the hydrocarbon is one or more of methane, ethane, propane and butane, preferably methane.
38. The process of any one of embodiments 1 to 37, wherein in the reactant gas stream passed into the reaction zone obtained from (ii), the volume ratio of the hydrocarbon to the carbon dioxide is in the range of from 0.75:1 to 1.25:1, preferably in the range of from 0.8:1 to 1.2:1, more preferably in the range of from 0.9:1 to 1.1:1, more preferably in the range of from 0.95:1 to 1.05:1.
39. The process of any one of embodiments 1 to 38, wherein in the reactant gas stream passed into the reaction zone obtained from (ii), the volume ratio of the hydrocarbon to the water is in the range of from 1.7:1 to 2.9:1, preferably in the range of from 1.8:1 to 2.8:1, more preferably in the range of from 1.85:1 to 2.75:1.
40. The process of any one of embodiments 1 to 39, wherein from 96 to 100 volume-%, preferably from 98 to 100 volume-%, more preferably from 99 to 100 volume-%, more preferably from 99.5 to 100 volume-% of the reactant gas stream passed into the reaction zone obtained from (ii) consist of the hydrocarbon, the carbon dioxide, and the water.
41. The process of any one of embodiments 1 to 40, wherein prior to passing through the reaction zone obtained from (ii), from 1 to 50 volume-%, preferably from 10 to 50 volume-%, more preferably from 30 to 50 volume-%, more preferably from 35 to 45 volume-%, more preferably from 37 to 40.5 volume-% of the reactant gas stream consist of the hydrocar-bon.
42. The process of any one of embodiments 1 to 41, wherein prior to passing through the reaction zone obtained from (ii), from 1 to 50 volume-%, preferably from 10 to 50 volume-%, more preferably from 30 to 50 volume-%, more preferably from 35 to 45 volume-%, more preferably from 37 to 40.5 volume-% of the reactant gas stream consist of carbon dioxide (CO₂).
43. The process of any one of embodiments 1 to 42, wherein prior to passing through the reaction zone obtained from (ii), from 1 to 50 volume-%, preferably from 5 to 35 volume-%, more preferably from 10 to 25 volume-%, more preferably from 12 to 23 volume-%, more preferably from 14 to 21 volume-% of the reactant gas stream consist of water (H₂O).
44. The process of any one of embodiments 1 to 43, wherein the reforming conditions in the reaction zone according to (iii) comprise a pressure of the gas phase in the range of from 1 to 50 bar(abs), preferably in the range of from 10 to 40 bar(abs), more preferably in the range of from 15 to 30 bar(abs), more preferably in the range of from 17 to 23 bar(abs), more preferably in the range of from 17 to 23 bar(abs), more preferably in the range of from 19 to 21 bar(abs), more preferably in the range of from 19.5 to 20.5 bar(abs).
45. The process of any one of embodiments 1 to 44, wherein the reforming conditions in the reaction zone according to (iii) comprise a gas hourly space velocity (GHSV) of the reactant gas stream in the range of from 1000 to 7500 per hour, preferably in the range of from 1250 to 7300 per hour, more preferably in the range of from 1500 to 7100 per hour, more preferably of from 3500 to 7500 per hour, more preferably of from 3700 to 7300 per hour, more preferably of from 3900 to 7100 per hour.
46. The process of any one of embodiments 1 to 45, wherein the reforming conditions in the reaction zone according to (iii) comprise a temperature of the gas phase in the reaction zone in the range of from 550 to 980° C., preferably in the range of from 575 to 975° C., more preferably in the range of from 600 to 950° C.
47. The process of any one of embodiments 1 to 46, wherein during (iii), the reforming conditions in the reaction zone comprise a setting (iii.1) and a setting (iii.2) realized directly after the setting (iii.1), wherein the setting (iii.1) differs from the setting (iii.2) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone.
48. The process of embodiment 47, wherein the volume ratios hydrocarbon:carbon dioxide:water in the reactant gas stream according to the setting (iii.1) are (2.5 to 2.9):(2.5 to 2.9):(0.8 to 1.2), preferably (2.55 to 2.8):(2.55 to 2.8):(0.9 to 1.1), more preferably (2.6 to 2.75):(2.6 to 2.75):(0.95 to 1.05).
49. The process of embodiment 47 or 48 wherein the temperature in the reaction zone according to the setting (iii.1) is in the range of from 550 to 980° C., preferably in the range of from 575 to 975° C., more preferably in the range of from 600 to 950° C., more preferably in the range of from 880 to 920° C., more preferably in the range of from 890 to 910° C., more preferably of from 895 to 905° C.
50. The process of any one of embodiments 48 to 49, wherein the gas hourly space velocity of the reactant gas stream according to the setting (iii.1) is in the range of from 1000 to 7500 per hour, preferably in the range of from 1250 to 7300 per hour, more preferably in the range of from 1500 to 7100 per hour, more preferably in the range of from 3700 to 4300 per hour, more preferably in the range of from 3800 to 4200 per hour, more preferably in the range of from 3900 to 4100 per hour.
51. The process of any one of embodiments 47 to 50, wherein the setting (iii.1) is maintained for a period of time in the range of from 1 to 10 h, preferably in the range of from 3 to 8 h, more preferably in the range of from 4 to 6 h.
52. The process of any one of embodiments 47 to 51, wherein the volume ratios hydrocarbon:carbon dioxide:water in the reactant gas stream according to the setting (iii.2) are (2.5 to 2.9):(2.5 to 2.9):(0.8 to 1.2), preferably (2.55 to 2.8):(2.55 to 2.8):(0.9 to 1.1), more preferably (2.6 to 2.75):(2.6 to 2.75):(0.95 to 1.05).
53. The process of any one of embodiments 47 to 52, wherein the temperature in the reaction zone according to the setting (iii.2) is in the range of from 550 to 980° C., preferably in the range of from 575 to 975° C., more preferably in the range of from 600 to 970° C., more preferably in the range of from 930 to 970° C., more preferably in the range of from 940 to 960° C., more preferably in the range of from 945 to 955° C.
54. The process of any one of embodiments 47 to 53, wherein the gas hourly space velocity according to the setting (iii.2) is in the range of from 1000 to 7500 per hour, preferably in the range of from 1250 to 7300 per hour, more preferably in the range of from 1500 to 7100 per hour, more preferably in the range of from 3700 to 4300 per hour, more preferably in the range of from 3800 to 4200 per hour, more preferably in the range of from 3900 to 4100 per hour.
55. The process of any one of embodiments 47 to 54, wherein the setting (iii.2) is maintained for a period of time in the range of from 10 to 50 h, preferably in the range of from 20 to 40 h, more preferably in the range of from 30 to 35 h.
56. The process of any one of embodiments 47 to 55, wherein during (iii), the reforming conditions in the reaction zone further comprise a setting (iii.3) realized directly after the setting (iii.2), wherein the setting (iii.3) differs from setting (iii.2) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone.
57. The process of embodiment 56, wherein the volume ratios hydrocarbon:carbon dioxide:water in the reactant gas stream according to the setting (iii.3) are (1.7 to 2.1):(1.7 to 2.1):(0.8 to 1.2), preferably (1.8 to 1.95):(1.8 to 1.95):(0.9 to 1.1), more preferably (1.85 to 1.9):(1.85 to 1.9):(0.95 to 1.05).
58. The process of embodiment 56 or 57, wherein the temperature in the reaction zone according to the setting (iii.3) is in the range of from 550 to 980° C., preferably in the range of from 575 to 975° C., more preferably in the range of from 600 to 970° C., more preferably in the range of from 930 to 970° C., more preferably in the range of from 940 to 960° C., more preferably in the range of from 945 to 955° C.
59. The process of any one of embodiments 56 to 58, wherein the gas hourly space velocity according to the setting (iii.3) is in the range of from 1000 to 7500 per hour, preferably in the range of from 1250 to 7300 per hour, more preferably in the range of from 1500 to 7100 per hour, more preferably of from 3700 to 4300 per hour, more preferably in the range of from 3800 to 4200 per hour, more preferably in the range of from 3900 to 4100 per hour.
60. The process of any one of embodiments 56 to 59, wherein the setting (iii.3) is maintained for a period of time in the range of from 5 to 50 h, preferably in the range of from 10 to 40 h, more preferably in the range of from 20 to 30 h.
61. The process of any one of embodiments 56 to 60, wherein during (iii), the reforming conditions in the reaction zone further comprise a setting (iii.4) realized directly after the setting (iii.3), wherein the setting (iii.4) differs from the setting (iii.3) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone.
62. The process of embodiment 61, wherein the volume ratios hydrocarbon:carbon dioxide:water in the reactant gas stream according to the setting (iii.4) are (1.7 to 2.1):(1.7 to 2.1):(0.8 to 1.2), preferably (1.8 to 1.95):(1.8 to 1.95):(0.9 to 1.1), more preferably (1.85 to 1.9):(1.85 to 1.9):(0.95 to 1.05).
63. The process of embodiment 61 or 62, wherein the temperature in the reaction zone according to the setting (iii.4) is in the range of from 550 to 980° C., preferably in the range of from 575 to 975° C., more preferably in the range of from 600 to 970° C., more preferably of from 930 to 970° C., more preferably in the range of from 940 to 960° C., more preferably in the range of from 945 to 955° C.
64. The process of any one of embodiments 61 to 63, wherein the gas hourly space velocity according to the setting (iii.4) is in the range of from 1000 to 7500 per hour, preferably in the range of from 1250 to 7300 per hour, more preferably in the range of from 1500 to 7100 per hour, more preferably of from 6700 to 7100 per hour, more preferably in the range of from 6800 to 7100 per hour, more preferably in the range of from 6900 to 7100 per hour.
65. The process of any one of embodiments 61 to 64, wherein the setting (iii.4) is maintained for a period of time in the range of from 2 to 30 hours, preferably in the range of from 5 to 20 h, more preferably in the range of from 10 to 15 h.
66. The process of any one of embodiments 61 to 65, wherein during (iii), the reforming conditions in the reaction zone further comprise a setting (iii.5) realized directly after the setting (iii.4), wherein the setting (iii.5) differs from the setting (iii.4) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone.
67. The process of embodiment 66, wherein the volume ratios hydrocarbon:carbon dioxide:water in the reactant gas stream according to the setting (iii.5) are (2.5 to 2.9):(2.5 to 2.9):(0.8 to 1.2), preferably (2.55 to 2.8):(2.55 to 2.8):(0.9 to 1.1), more preferably (2.6 to 2.75):(2.6 to 2.75):(0.95 to 1.05).
68. The process of embodiment 66 or 67 wherein the temperature in the reaction zone according to the setting (iii.5) is in the range of from 550 to 980° C., preferably in the range of from 575 to 975° C., more preferably in the range of from 600 to 970° C., more preferably of from 930 to 970° C., more preferably in the range of from 940 to 960° C., more preferably in the range of from 945 to 955° C.
69. The process of any one of embodiments 66 to 68, wherein the gas hourly space velocity according to the setting (iii.5) is in the range of from 1000 to 7500 per hour, preferably in the range of from 1250 to 7300 per hour, more preferably in the range of from 1500 to 7100 per hour, more preferably of from 6700 to 7100 per hour, more preferably in the range of from 6800 to 7100 per hour, more preferably in the range of from 6900 to 7100 per hour.
70. The process of any one of embodiments 66 to 69, wherein the setting (iii.5) is maintained for a period of time in the range of from 2 to 30 h, preferably in the range of from 5 to 20 h, more preferably in the range of from 10 to 15 h.
71. The process of any one of embodiments 66 to 70, wherein during (iii), the reforming conditions in the reaction zone further comprise a setting (iii.6) realized directly after the setting (iii.5), wherein the setting (iii.6) differs from the setting (iii.5) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone.
72. The process of embodiment 71, wherein the volume ratios hydrocarbon:carbon dioxide:water in the reactant gas stream according to the setting (iii.6) are (1.7 to 2.1):(1.7 to 2.1):(0.8 to 1.2), preferably (1.8 to 1.95):(1.8 to 1.95):(0.9 to 1.1), more preferably (1.85 to 1.9):(1.85 to 1.9):(0.95 to 1.05).
73. The process of embodiment 71 or 72 wherein the temperature in the reaction zone according to the setting (iii.6) is in the range of from 550 to 980° C., preferably in the range of from 575 to 975° C., more preferably in the range of from 600 to 970° C., more preferably of from 930 to 970° C., more preferably in the range of from 940 to 960° C., more preferably in the range of from 945 to 955° C.
74. The process of any one of embodiments 71 to 73, wherein the gas hourly space velocity according to the setting (iii.6) is in the range of from 1000 to 7500 per hour, preferably in the range of from 1250 to 7300 per hour, more preferably in the range of from 1500 to 7100 per hour, more preferably of from 3700 to 4300 per hour, more preferably in the range of from 3800 to 4200 per hour, more preferably in the range of from 3900 to 4100 per hour.
75. The process of any one of embodiments 71 to 74, wherein the setting (iii.6) is maintained for a period of time in the range of from 2 to 30 h, preferably in the range of from 5 to 20 h, more preferably in the range of from 10 to 15 h.
76. The process of any one of embodiments 71 to 75, wherein during (iii), the reforming conditions in the reaction zone further comprise one or more settings (iii.x) realized after the setting (iii.6), wherein each of the settings (iii.x) differs from the setting (iii.x-1) in at least one of
   (a) the volume ratios of hydrocarbon:carbon dioxide:water in the reactant gas stream passed into the reaction zone;
   (b) the temperature in the reaction zone;
   (c) the gas hourly space velocity of the reactant gas stream passed into the reaction zone;
wherein x is an integer andx>6.

The present invention is further illustrated by the following examples and reference examples.

### EXAMPLES

### Reference Example 1: Determination of the BET Specific Surface Area and of the Langmuir Specific Surface Area

The BET specific surface area and the Langmuir specific surface area were determined via nitrogen physisorption at 77 K according to the method disclosed in DIN 66131.

### Reference Example 2: Determination of Crystallinity Via XRD

Powder X-ray Diffraction (PXRD) data was collected using a laboratory diffractometer (D8 Dis-cover, Bruker AXS GmbH, Karlsruhe). The instrument was set up with a Molybdenum X-ray tube. The characteristic K-alpha radiation was monochromatized using a bent Germanium Jo-hansson type primary monochromator. Data was collected in the Bragg-Brentano reflection geometry. A LYNXEYE area detector was utilized to collect the scattered X-ray signal.

The powders were ground using an IKA Tube Mill and an MT40.100 disposable grinding chamber. The powder was placed in a sample holder and flattened unsing a glas plate.

Data analysis was performed using DIFFRAC.EVA V4 and DIFFRAC.TOPAS V4 software (Bruker AXS GmbH). DIFFRAC.EVA was used to estimate the crystallinity. Default values were used as input for the algorithm (DIFFRAC.EVA User Manual, 2014, Bruker AXS GmbH, Karlsruhe).

All other parameters were determined using DIFFRAC.TOPAS. The entire diffraction pattern was simulated using the crystal structures of hexagonal LaCoAl₁₁O₁₉, rhombohedral LaAlO₃, cubic CoAl₂O₄, hexagonal La(OH)₃, cubic Co-doped LaAlO₃ and Corundum. During the simulation 29 parameters are refined to fit the simulated diffraction to the measured data. The parameters are listed in the following table 1.

TABLE 1
Parameters for refining

| | | No. of |
|---|---|---|
| Parameter | Structure | variables |
| Background via Chebychev | global | 2 |
| polynomi- | | |
| Background via peak at ca. | global | 3 |
| 6.6° 2• | | |
| Specimen displacement | global | 1 |
| | hexagonal LaCoAl₁₁O₁₉ | |
| Crystallite size | | 1 |
| Scale factor | | 1 |
| Lattice | | 2 |
| Preferred orientation* | | 1 |
| | cubic Co-doped LaAlO₃ | |
| Crystallite size | | 1 |
| Scale factor | | 1 |
| Lattice | | 1 |
| Co doping factor | | 1 |
| | rhombohedral LaAlO₃ | |
| Crystallite size | | 1 |
| Scale factor | | 1 |
| Lattice | | 2 |
| | Corundum | |
| Crystallite size | | 1 |
| Scale factor | | 1 |
| Lattice | | 2 |
| | cubic CoAl₂O₄ | |
| Crystallite size | | 1 |
| Scale factor | | 1 |
| Lattice | | 1 |
| | hexagonal La(OH)₃ | |
| Scale factor | | 1 |
| Lattice | | 2 |

*Using the March-Dollase model along the (1 1 0) direction.

The crystal structures used were all retrieved from the inorganic crystal structure database (ICSD) (ICSD, FIZ Karlsruhe (https:H/icsd.fiz-karlsruhe.de/)) or the Pearson's Crystal Data (PCD) (Pearsons Crystal Data—Crystal Structure Database for Inorganic Compounds, Release 2016/2017, ASM International, Materials Park, Ohio, USA). The following table 2 lists the reference numbers of the structures used.

TABLE 2
Numbers of structures used

| | ICSD Number | PCD Number |
|---|---|---|
| hexagonal LaCoAl₁₁O₁₉ | | 1502158 |
| cubic Co-doped LaAlO₃ | | 1501066 |
| rhombohedral LaAlO₃ | 28629 | |
| Corundum | | 1520618 |
| cubic CoAl₂O₄ | 163275 | |
| hexagonal La(OH)₃ | 192271 | |

The crystallite size values are those reported as Lvol-FWHM in DIFFRAC.TOPAS. To ensure reliable crystallite size values the geometry of the diffractometer was entered into the software to enable the calculation of the instrumental resolution based on the fundamental parameter approach (DIFFRAC.TOPAS User Manual, 2014, Bruker AXS GmbH, Karlsruhe). Scale factors are recomputed into mass percent values by DIFFRAC.TOPAS and have been reported.

### Example 1: Preparation of a Mixed Oxide Comprising Cobalt and Oxygen

The mixed oxide that has been tested as catalyst in the process for producing synthesis gas was prepared according to the following synthesis procedure: 6 kg of aqueous AlOOH (Disperal®, Sasol, containing 78 weight-% of Al₂O₃), 1.95 kg of Co(NO₃)₂·6H₂O (Merck, having a purity of 97%) and 4.8 kg of La(NO₃)₃·6H₂O (Fluka, having a purity of 99%) were homogeneously mixed in a kneader and 850 ml of water were added. The mixture was extruded to 4 mm cylinders. These strands were dried at 105° C. for 16 h in a muffle furnace. The dried strands were then calcined in a muffle furnace in the following sequence: a) at 490° C. for 15 min, b) at 520° C. for 120 min. Subsequently, the calcined strands were split to particles having a diameter in the range of from 0.5 to 1.0 millimeter and finally calcined in air at 1100° C. for 30 h.

The obtained mixed oxide comprised 36 weight-% of aluminum, 5.8 weight-% of cobalt and 23 weight-% of lanthanum, each calculated as element. The BET specific surface area of the final catalyst was 11 m²/g, as determined according to reference example 1.

### Example 2: Catalytic Testing

Catalytic tests were performed on a test unit comprising a single reactor. This unit enables test conditions in a broad temperature and pressure regime up to 1100° C. (at 1.000 bar) and 20 bar (at max. 950° C.). As gas feeds for the reactant gas stream carbon dioxide, methane, hydrogen, nitrogen and argon are provided and online controlled by mass flow controllers (MFCs). Water as steam was added to the gas feed stream by an evaporator connected to a water reservoir, whereby the dosing to the evaporator was performed by a high performance liquid chromatography (HPLC) pump controlled by a flow meter. The analysis of the product stream composition was carried out by online-gas chromatography using Ar as internal standard. Gas chromatography-analysis enabled the quantification of hydrogen, carbon monoxide, carbon dioxide, methane and C₂-components. Duration of the gas chromatography-method was approx. 24 min.

For catalytic tests, 15 ml catalyst as split (particle diameter of 0.5 to 1.0 μm) was used. The sample was placed in the isothermal zone of the reactor using a ceramic fitting. Prior to the start of the experiment the back pressure was determined.

Based on the quantification of the product stream the methane conversion and carbon dioxide-conversion were calculated according to equation [1] and [2].

$$C {H}_{4} ‐ conversion : x ( {CH}_{4} ) = 1 - ( {CH}_{4} ‐ out / {CH}_{4} ‐ in ) \qquad [ 1 ]$$

$$C {O}_{2} ‐ conversion : x ( {CO}_{2} ) = 1 - ( C {O}_{2} ‐ out / C {O}_{2} ‐ in ) \qquad [ 2 ]$$

The gas hourly space velocity (GHSV) is defined according to equation [3]

$$GHSV = flow rate of the entire gas stream [ L / h ] / volume of catalyst fraction [ L ] \qquad [ 3 ]$$

### Comparative Example 2.1: Catalytic Testing of the Catalyst of Example 1 in a Common Process

The reaction parameters which are commonly used in a process for converting methane to synthesis gas are summarized in table 3. The process starts with a reaction phase in which only methane and water are used in a gas feed stream, followed by a time-consuming phase in which the methane and steam are partially substituted by carbon dioxide. The pressure was 20 bar(abs).

TABLE 3
Reaction conditions and sequences commonly used in a comparative
process for producing synthesis gas

| Time | | Temperature | | | | |
|---|---|---|---|---|---|---|
| on | | of the | CH₄/ | CO₂/ | H₂O/ | |
| stream/ | Duration/ | reactor | volume- | volume- | volume- | GHSV/ |
| h | h | wall/° C. | % | % | % | h⁻¹ |
| 0.0 | 10.0 | 900 | 47.5 | 0 | 47.5 | 4000 |
| 10.9 | 20.6 | 900 | 3167 | 31.66 | 31.67 | 4000 |
| 32.5 | 22.6 | 900 | 37.5 | 37.5 | 20 | 4000 |
| 56.4 | 45.8 | 950 | 37.5 | 37.5 | 20 | 4000 |
| 102.8 | 22.8 | 950 | 37.5 | 37.5 | 20 | 6000 |
| 126.2 | 34.0 | 950 | 40 | 40 | 15 | 6000 |
| 160.9 | 10.0 | 950 | 37.5 | 37.5 | 20 | 6000 |
| 177.6 | 39.5 | 950 | 40 | 40 | 15 | 4000 |

The resulting activities for the preparation of a synthesis gas according to the present invention are summarized in FIG. 1.

### Example 2.2: Catalytic Testing of the Catalyst of Example 1 in a Process According to the Present Invention

The reaction parameters which are used to obtain an improved activity according to the process of the present invention are summarized in table 4. In this case, the process starts from the very beginning with a reactant gas stream which contains methane, carbon dioxide and water. The pressure was 20 bar(abs).

TABLE 4
Reaction conditions and sequences used in the process according to
the present invention

| Time | | Temperature | | | | |
|---|---|---|---|---|---|---|
| on | | of the | CH₄/ | CO₂/ | H₂O/ | |
| stream/ | Duration/ | reactor | volume- | volume- | volume- | GHSV/ |
| h | h | wall/° C. | % | % | % | h⁻¹ |
| 0.0 | 5.8 | 900 | 40 | 40 | 15 | 4000 |
| 7.3 | 32.5 | 950 | 40 | 40 | 15 | 4000 |
| 40.8 | 24.8 | 950 | 37.5 | 37.5 | 20 | 4000 |
| 66.6 | 12.1 | 950 | 37.5 | 37.5 | 20 | 7000 |
| 79.5 | 11.5 | 950 | 40 | 40 | 15 | 7000 |
| 91.9 | 11.6 | 950 | 37.5 | 37.5 | 20 | 4000 |

The resulting activities for the preparation of a synthesis gas according to the present invention are shown in FIG. 2. As can be seen from FIG. 2, the activity of the catalyst used in the inventive process in accordance with example 2.2 is twice as high as in comparative example 2.1, in particular by using the process conditions as described in Table 4. It can be particularly gathered from FIG. 2 that the CO₂-conversion does not fall under 50%, and the CH₄-conversion does not fall under 45%. In comparison thereto, it can be seen in FIG. 1 that for a process according to the prior art the CO₂-conversion does not reach 45%, and the CH₄-conversion does not reach 50%. This is all the more surprising since the same conditions have been applied for both the inventive example and the comparative example including changes of the temperature, the gas hourly space velocity and the composition of the gas feed, whereby the content of steam, methane and carbon dioxide in the gas feed were changed over the time.

### BRIEF DESCRIPTION OF FIGURES

FIG. 1: shows on the ordinate (left) the carbon dioxide and methane conversion in % for a common prior art process for producing a synthesis gas. The temperature, the composition of the gas feed stream, and the gas hourly space velocity GHSV are also shown on the ordinate (right). The time on stream TOS is shown on the abscissa.

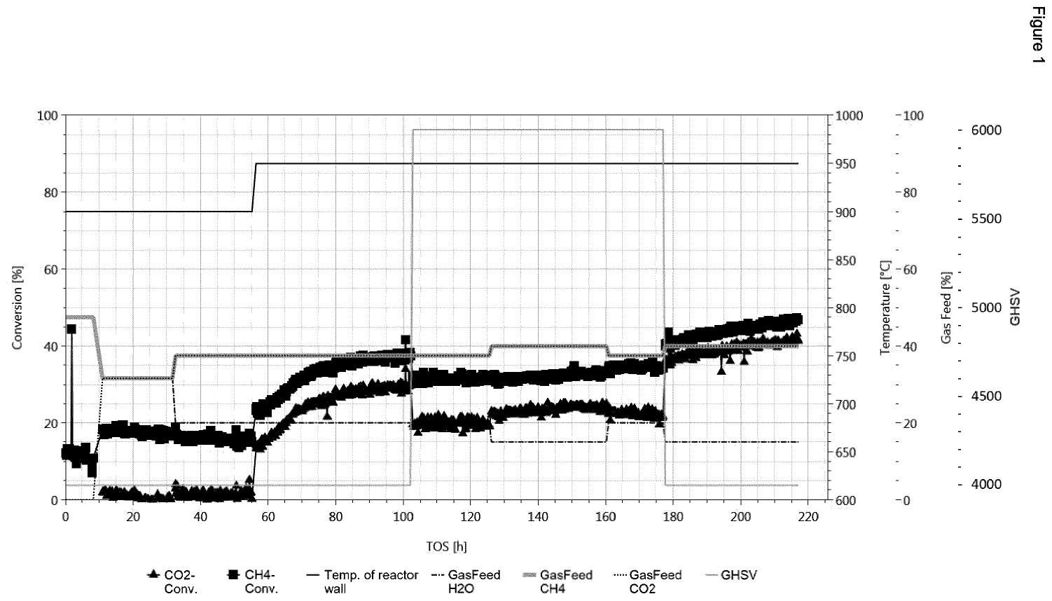

FIG. 2: shows on the ordinate (left) the carbon dioxide and methane conversion in % for a process according to the present invention for producing a synthesis gas. The temperature, the composition of the reactant gas stream, and the gas hourly space velocity GHSV are also shown on the ordinate (right). The time on stream TOS is shown on the abscissa.

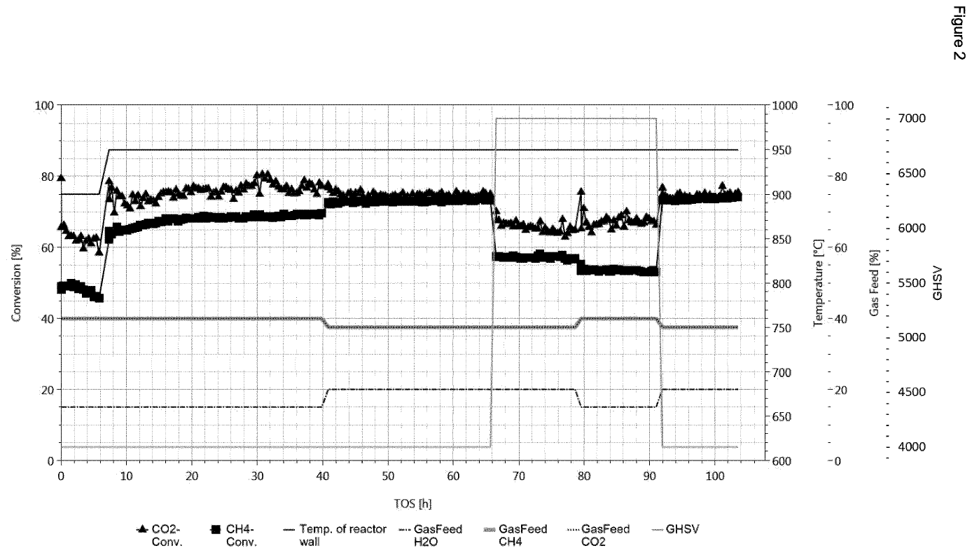

### CITED LITERATURE

WO 2013/118078 A1
U.S. Pat. No. 9,259,712 B2

1-15. (canceled)

16. A continuous process for reforming one or more hydrocarbons to a synthesis gas comprising hydrogen and carbon monoxide, the start-up phase of said process comprising
(i) providing a reactor comprising a reaction zone which comprises a catalyst comprising a mixed oxide comprising cobalt and oxygen;
(ii) continuously passing an inert gas stream through the reaction zone according to (i), said inert gas stream comprising one or more inert gases;
(iii) continuously passing a reactant gas stream into the reaction zone obtained from (ii), wherein from 95 to 100 volume % of the reactant gas stream passed into the reaction zone consist of the one or more hydrocarbons, carbon dioxide, and water;
subjecting said reactant gas stream to reforming conditions in said reaction zone; and
removing a product stream from said reaction zone, said product stream comprising hydrogen and carbon monoxide.

17. The process of claim 16, wherein the catalyst is a molding.

18. The process of claim 16, wherein the mixed oxide further comprises one or more of lanthanum and aluminum.

19. The process of claim 16, wherein the mixed oxide further comprises aluminum, and wherein in the mixed oxide, the weight ratio of cobalt relative to aluminum, calculated as elements, is at least 0.1:1.

20. The process of claim 16, wherein prior to passing the reactant gas stream into the reactor according to (iii), the reaction zone obtained from (ii) comprises from 0 to 0.1 volume % of oxygen (O₂).

21. The process of claim 16, wherein prior to (iii), no reactant stream comprising one or more of a hydrocarbon and water, said stream comprising from 0 to 0.1 volume % carbon dioxide, is passed into the reaction zone according to (i).

22. The process of claim 16, wherein prior to (iii), no stream consisting of from 95 to 100 volume-% of one or more of a hydrocarbon and water, is passed into the reaction zone according to (i).

23. The process of claim 16, wherein the reaction zone obtained from (ii) and prior to (iii) comprises from 0 to 0.1 volume-% of one or more of carbon dioxide and oxygen (O₂).

24. The process of claim 16, wherein the hydrocarbon is one or more of methane, ethane, propane and butane.

25. The process of claim 16, wherein in the reactant gas stream passed into the reaction zone obtained from (ii), the volume ratio of the hydrocarbon to the carbon dioxide is in the range of from 0.75:1 to 1.25:1.

26. The process of claim 16, wherein in the reactant gas stream passed into the reaction zone obtained from (ii), the volume ratio of the hydrocarbon to the water is in the range of from 1.7:1 to 2.9:1.

27. The process of claim 16, wherein prior to passing through the reaction zone obtained from (ii), from 1 to 50 volume % of the reactant gas stream consist of the hydrocarbon.

28. The process of claim 16, wherein prior to passing through the reaction zone obtained from (ii), from 1 to 50 volume-% of the reactant gas stream consist of carbon dioxide (CO₂).

29. The process of claim 16, wherein prior to passing through the reaction zone obtained from (ii), from 1 to 50 volume-% of the reactant gas stream consists of water (H₂O).

30. The process of claim 16, wherein during (iii), the reforming conditions in the reaction zone comprise a setting (iii.1) and a setting (iii.2) realized directly after the setting (iii.1), wherein the setting (iii.1) differs from the setting (iii.2) in at least one of
(a) the volume ratios of hydrocarbon:carbon dioxide:water in the reactant gas stream passed into the reaction zone;
(b) the temperature in the reaction zone;
(c) the gas hourly space velocity of the reactant gas stream passed into the reaction zone.
